(19) United States
(12) Patent Application Publication
(10) Pub. No.: US 2024/0236836 A1
(43) Pub. Date: Jul. 11, 2024

(54) RADIO ACCESS NETWORK COMPUTING SERVICE SUPPORT WITH DISTRIBUTED UNITS

(71) Applicant: Intel Corporation, Santa Clara, CA (US)

(72) Inventors: Sangeetha L. BANGOLAE, Santa Clara, CA (US); Zongrui DING, Portland, OR (US); Alexandre Saso STOJANOVSKI, Paris 75 (FR); Qian LI, Portland, OR (US); Sudeep PALAT, Gloucestershire (GB); Thomas LUETZENKIRCHEN, Taufkirchen BY (DE); Youn Hyoung HEO, Santa Clara, CA (US); Ching-Yu LIAO, Santa Clara, CA (US); Abhijeet KOLEKAR, Portland, OR (US)

(21) Appl. No.: 18/558,700

(22) PCT Filed: Aug. 10, 2022
(86) PCT No.: PCT/US2022/039927

§ 371 Date: Nov. 2, 2023

Related U.S. Application Data
(60) Provisional application No. 63/233,159, filed on Aug. 13, 2021.

(51) Int. Cl. H04W 48/18; H04W 8/22; H04W 76/20

(52) U.S. Cl. CPC H04W 48/18; H04W 8/22; H04W 76/20

(57) ABSTRACT

Various embodiments herein are directed to radio access network (RAN) computing service support with distributed units (DUs). In particular, some embodiments are directed to to the architecture and corresponding control plane functions and protocols for RAN-based computation offloading using compute resource at a next-generation NodeB (gNB) DU. Other embodiments be disclosed or claimed.

### CROSS REFERENCE TO RELATED APPLICATION

The present application claims priority to U.S. Provisional Patent Application No. 63/233,159, which was filed Aug. 13, 2021.

### FIELD

Various embodiments generally may relate to the field of wireless communications. For example, some embodiments may relate to radio access network (RAN) computing service support with distributed units (DUs). In particular, some embodiments are directed to the architecture and corresponding control plane functions and protocols for RAN-based computation offloading using compute resource at a next-generation NodeB (gNB) DU.

### BACKGROUND

Modern cloud computing has become extremely popular to provide computing/storage capability to customers who can focus more on the software (SW) development and data management without worrying too much about the underlying infrastructure. Edge computing is believed to extend this capability close to the customers to optimize performance metrics such as latency. The 5G architecture design takes these scenarios into considerations and developed multi-homing, ULCL (Uplink Classifier) framework to offload compute tasks to different data networks (DNs), which may be at the network edge. For a user equipment (UE) with limited computing capabilities, the application can be rendered at the cloud/edge for computing offloading based on an application level logic above the operating system (OS).

With the trend of Telco network cloudification, the cellular network is foreseen to be built with flexibility and scalability by virtualized network functions (VNFs) or containerized network functions (CNFs) running on general purpose hardware. Heterogeneous computing capabilities provided by hardware and software, naturally coming with this trend, can be leveraged to provide augmented computing to end devices across device and network. These computing tasks generally have different requirements in resource and dependencies in different scenarios.

For example, it can be an application instance either standalone or serving one or more UEs. It can also be a generic function like artificial intelligence (AI) training or inference or a micro-service function using specific accelerators. In addition, the computing task can be semi-static or dynamically launched. To enable these scenarios, this disclosure proposes solutions to enable augmented computing across the device and RAN in order to dynamically offload workloads and execute compute tasks at the network computing infrastructure with low latency and better computing scaling. Embodiments of the present disclosure address these and other issues.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of an architecture to enable augmented computing in RAN in accordance with various embodiments.

FIG. 2 illustrates an example of a RAN architecture with xNB and computing functions in accordance with various embodiments.

FIG. 3 illustrates an example of an overall NG-RAN architecture in accordance with various embodiments.

FIG. 4A illustrates an example of a protocol stack for a RAN computing control plane in accordance with various embodiments.

FIG. 4B illustrates an example of a protocol stack for RAN computing user plane for service-level computing offloading in accordance with various embodiments.

FIG. 5 illustrates an example of a computing distributed unit (Comp DU) supporting direct access to a RAN compute Service function (RAN Comp SF1) in accordance with various embodiments.

FIG. 6 illustrates an example of a CP architecture for the RAN Compute DU from the network perspective in accordance with various embodiments.

FIG. 7A illustrates an example of an UP architecture for the RAN Compute DU from the network perspective with an explicit interface to a RAN Comp SF (left diagram) and with collocated Compute resources (right diagram) in accordance with various embodiments

FIG. 7B illustrates an example of an UP architecture for the RAN Compute DU from the network perspective with communication DU and Comp DU collocated with each other in accordance with various embodiments.

FIG. 8 illustrates an example of a CP and UP architecture for RAN Compute DU from the UE perspective in accordance with various embodiments.

FIG. 9 illustrates an example of a CP protocol stack for RAN Compute at DU architecture in accordance with various embodiments.

FIG. 10 illustrates an example of an UP protocol stack for RAN Compute at DU architecture in accordance with various embodiments.

FIG. 11 illustrates an example of resource discovery exchange between UE and DU in accordance with various embodiments.

FIG. 12 illustrates an example of a Comp RRC-based RAN compute exchange using Comp DU with option 2 (service level compute) in accordance with various embodiments.

FIG. 13 illustrates an example of Comp RRC based RAN compute using Comp DU with option 1 (resource level compute) in accordance with various embodiments.

FIG. 14 schematically illustrates a wireless network in accordance with various embodiments.

FIG. 15 schematically illustrates components of a wireless network in accordance with various embodiments.

FIG. 16 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 17, 18, and 19 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein include disclosure regarding the following for RAN compute offloading at the DU, including:
High level architecture;
Enabling network support;
Protocol stack support;
UE access for compute service and Comp RRC introduction; and
Maintenance/management of UE contexts

Conventional systems do not provide solutions for transport of augmented computing and dynamic workload migration using compute resource at the gNB DU. Additionally, there are no previous solutions for transport of augmented computing and dynamic workload migration using compute resource at the gNB DU in the cellular network

Embodiments of the disclosure, by contrast, may help enable augmented computing as a service or network capability in 6G networks, compute client service function (Comp CSF) at the UE side, compute control function (Comp CF) and compute service function (Comp SF) at the network side are defined and known as a “compute plane” or “computing plane” functions to handle computing related control and user traffic.

The compute task generated at the UE/Comp CSF needs to be transported to the RAN Comp SF. Some embodiments herein are directed to the architecture and corresponding control plane functions and protocols for RAN-based computation offloading using compute resource at the gNB DU.

There are several advantages of using a compute resource at the gNB DU. For example, it helps provide easy and quick access to computing support. Additionally, support of infrastructure to ensure compute functionality is available to the UE even under different communication RRC states.

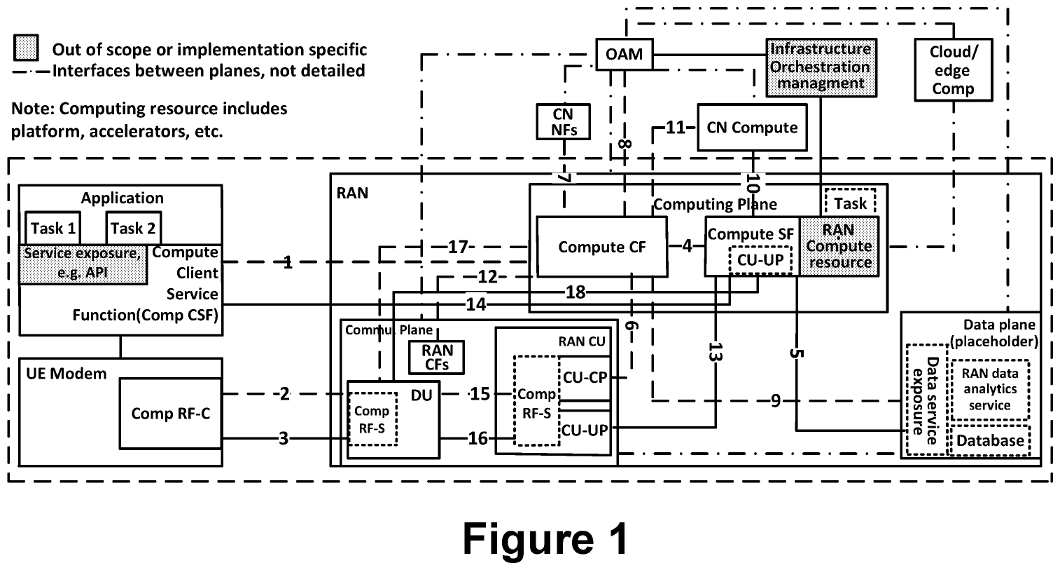

The Detailed RAN Architecture with Computing Functions is shown in FIG. 1. As shown in FIG. 1, the overall architecture of RAN is inside the black box and include a communication plane, computing plane and data plane. The functions proposed to enable network computing are RAN computing client service function (Comp CSF) at the UE side, the RAN computing control function (Comp CF) and the RAN computing service function (Comp SF) at the network side.

The reference points are as follows:
1. Between RAN Comp client and RAN Comp CF
2. Between UE and RAN DU
3. Between UE and RAN DU
4. Between RAN Comp CF and SF
5. Between RAN Comp SF and data plane
6. Between RAN Comp CF and RAN CU-CP or CU-UP
7. Between RAN Comp CF and CN NFs, e.g., NEF, PCF, AMF
8. Between RAN Comp CF and OAM
9. Between RAN Comp CF and data plane
10. Between RAN Comp SF and CN Comp SF
11. Between RAN Comp CF and CN Comp CF
12. Between RAN Comp CF and RAN CF,
13. Between RAN Comp SF and RAN CU-CP or CU-UP
14. Between RAN Comp Client and RAN Compute SF
15. Between RAN DU and RAN CU-CP
16. Between RAN DU and RAN CU-UP
17. Between RAN DU and RAN Comp CF
18. Between RAN DU and RAN Comp SF

Note: Reference point 1 and 14 are logical and may be mapped to a combination of other reference points. Additionally, in various embodiments a Comp RRC can be any generic control plane signaling including current RRC (as per 5G). Furthermore, while some embodiments are described in conjunction with computing task offloading, this is but one example of the usage of embodiments of the disclosure and some embodiments may operate with any other special/individualized service as well.

### RAN Architecture

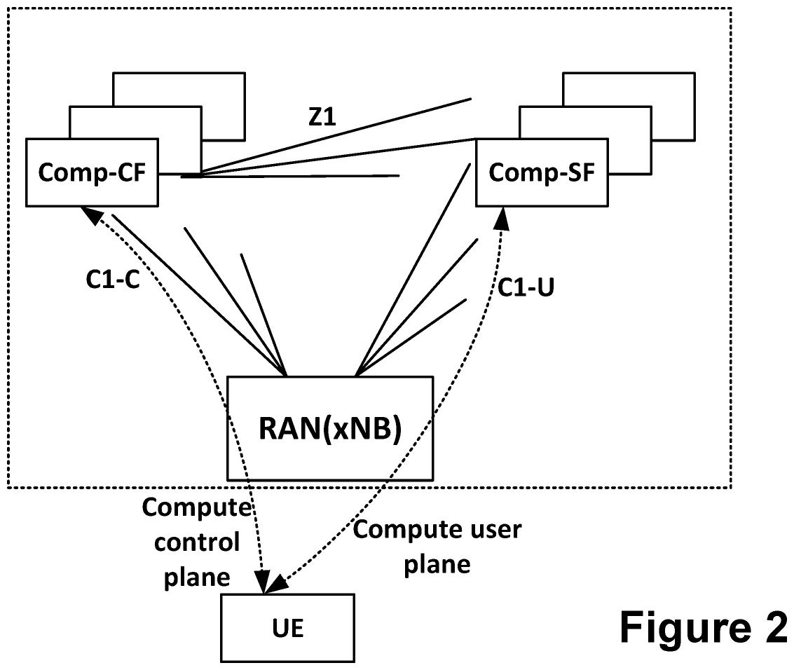

An example of the architecture for RAN and its high-level relationship to computing functions in accordance with various embodiments is shown in FIG. 2 wherein it can be seen that a given xNB may have connectivity using interface C1 to Compute CF and Compute SF functions. The dotted box around these entities indicate that the compute functions may be collocated with the xNB.

As part of the dynamic distribution of compute intensive workload between UE and Network, a transport protocol design for offloading compute intensive workload over user plane and control plane was considered for collocated and non-collocated scenarios assuming FIG. 2. A corresponding RAN compute session establishment procedure for support of IP and Non-IP based radio interface protocol design may also be defined in various embodiments. In the present disclosure, assuming the same baseline, the architecture, functions and protocol stack for the case when the RAN Compute resources are located at the cell site along with what is termed today as DU or Distributed Unit are discussed.

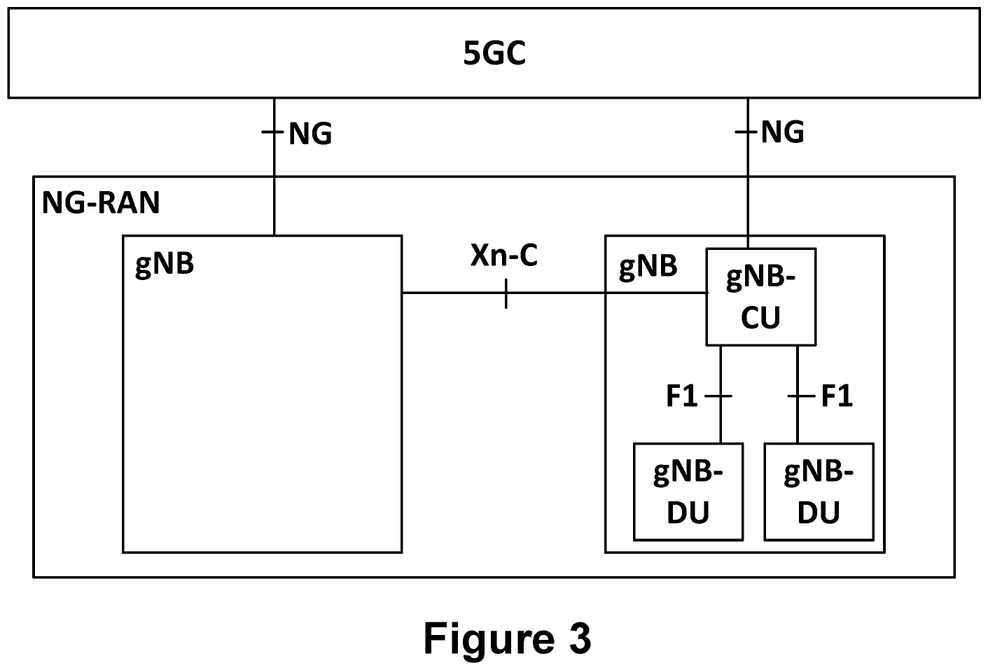

The overall NG-RAN architecture as per the TS 38.401 specification is shown in FIG. 3. In this example, one gNB may include one gNB-CU and one or more gNB-DUs connected with each other using the F1 interface. One gNB DU may connect to only one gNB-CU for control plane. Although different protocol stack options for the split architecture were discussed, the most common one is the case where the DU carries the PHY, MAC and RLC and the CU carries the PDCP and SDAP layers. The DU is generally considered the cell site connecting to the CU, sometimes in the cloud.

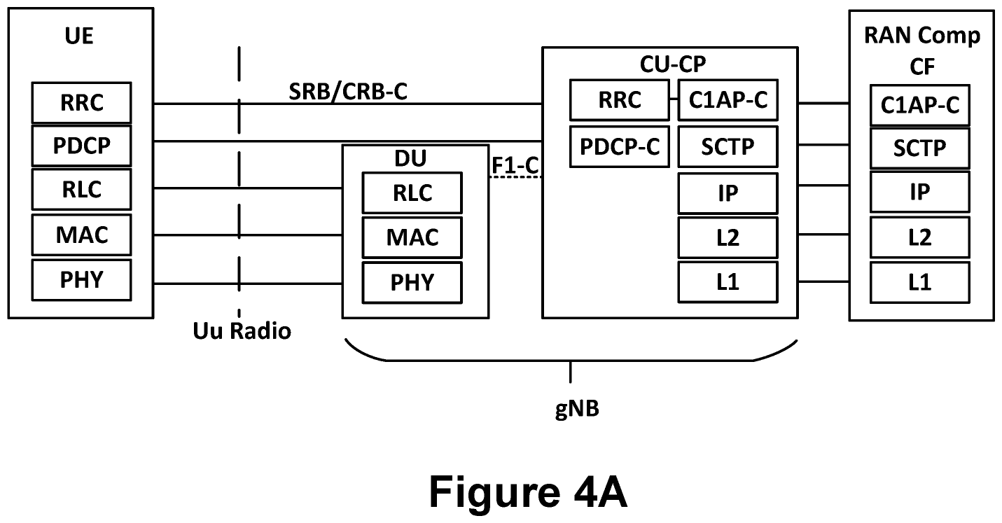

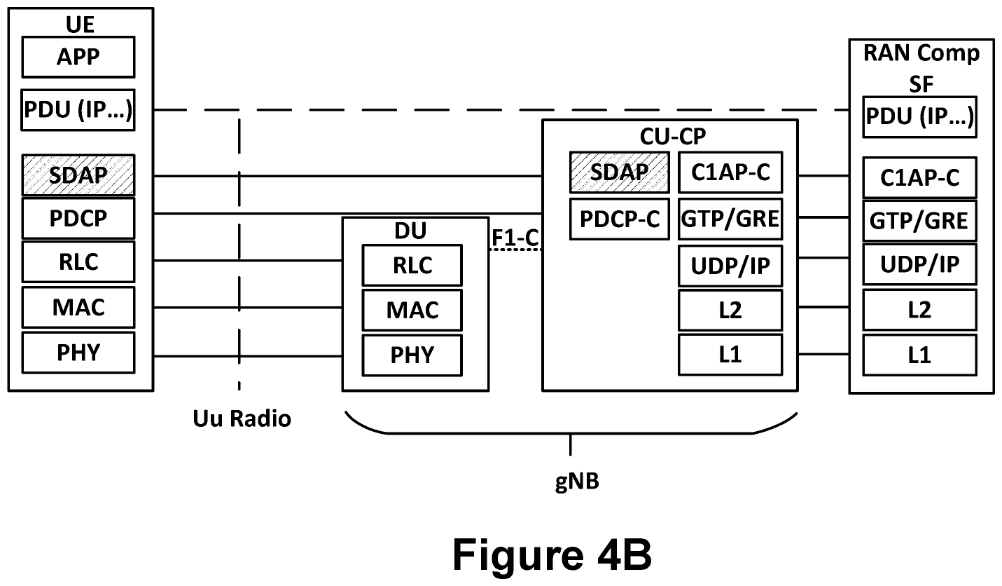

In some embodiments, by supporting RAN-based computing, the compute resources can be moved from the core network to the RAN for a variety of advantages, including latency reduction. The high-level protocol stack model for this original architecture model is shown in FIGS. 4A and 4B, for control plane and user plane, respectively. In the control plane case, the gNB DU is connected to the CU-CP using F1-C and the CU-CP connects to the RAN Compute Control Function (RAN Comp CF) to set up the UE's Compute bearer and UE context in the NG-RAN.

In the user plane, it is shown that the gNB CU-UP is directly connected to the RAN Compute Service Function which supports the Compute services for the UE. It is also shown that the RAN Comp SF may be collocated with the CU-UP rather than connect using an external interface (e.g. C1AP).

Throughout the present disclosure, gNB and xNB are used interchangeably with gNB referring to 5G based RAN design and xNB referring to future RAN nodes, but gNB methods can be interpreted as applicable to xNB as well.

### Embodiment (1) High-Level Architecture to Support Compute Offloading at the DU

In some embodiments, compute service support is fundamentally different from communication service and provides solutions that cater to the demanding QoS needs of the compute service. Considering the baseline split architecture as shown in FIG. 3 to support communication framework, some embodiments may define a new architecture model wherein:
a) Option 1: The gNB DU houses the RAN Compute resource for easy and quick access. This corresponds to resource-level compute offloading.
b) Option 2: The gNB DU is connected to RAN Comp SF and RAN Comp CF functions that contain the resources. This corresponds to service-level compute offloading.

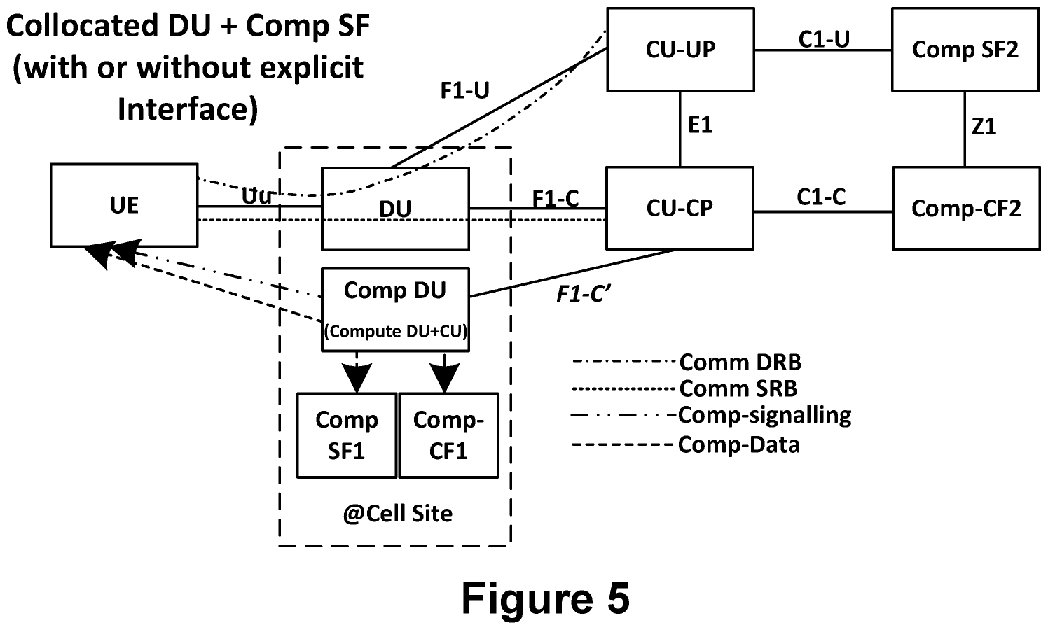

Since the devices (e.g. IoT type UE) are primarily looking for offloading computing services, the compute resource may be moved as close to the devices as possible. Unlike a communication scenario, where the UE is specifically interested in communicating with a server in the core network, in a computing service case, the UE is mostly looking for a powerful machine that can perform computation services (potentially falling into well-defined categories). The block diagram of the new architecture with localized RAN Compute resource available at cell site is shown in FIG. 5. Throughout the present disclosure, either option 1 or option 2 is shown for reference and it is to be noted that both options are suitable and applicable in all scenarios and showcased one way or another primarily for convenience.

In FIG. 5, there is a communication DU as per legacy that connects to the gNB-CU which in turn could have its own RAN Compute service function.

In one example deployment, a Comp DU collocated with the legacy DU at the cell site can be defined to support RAN Compute Service Function as well as potentially RAN Compute Control function. As explained above, it could be resource-level or service-level support. In an extended example, the legacy DU may or may not have a direct interface with the compute DU node or it may connect indirectly through the gNB-CU node. In legacy networks, the DU is connected to the CU using the F1 interface. In the new deployment, given the Comp DU may support the logical layers of both the legacy DU and CU (e.g. it may support PHY, MAC, RLC, PDCP and SDAP), the interface to the CU-CP may need to be modified accordingly.

### Embodiment (2) Network Support of RAN Compute Offloading at the DU

The functions of the logical gNB node, Compute DU or complete Compute DU or functional compute DU indicating that the Compute DU also includes the PDCP and SDAP layers, may be limited such that it may or may not initiate system level broadcast information. In one example, it could provide information on its capabilities to the gNB CU which then broadcasts accordingly (if this function is supported at all or most of the DUs as per the deployment) or it may be broadcast by the DU in a limited system information.

In another example, the network capability of RAN compute at DU may also be provided in dedicated signalling by the RRC at Comp DU or communication DU/CU as per configuration depending on whether the support is uniform across all the cells within the RNA (potentially to enable mobility).

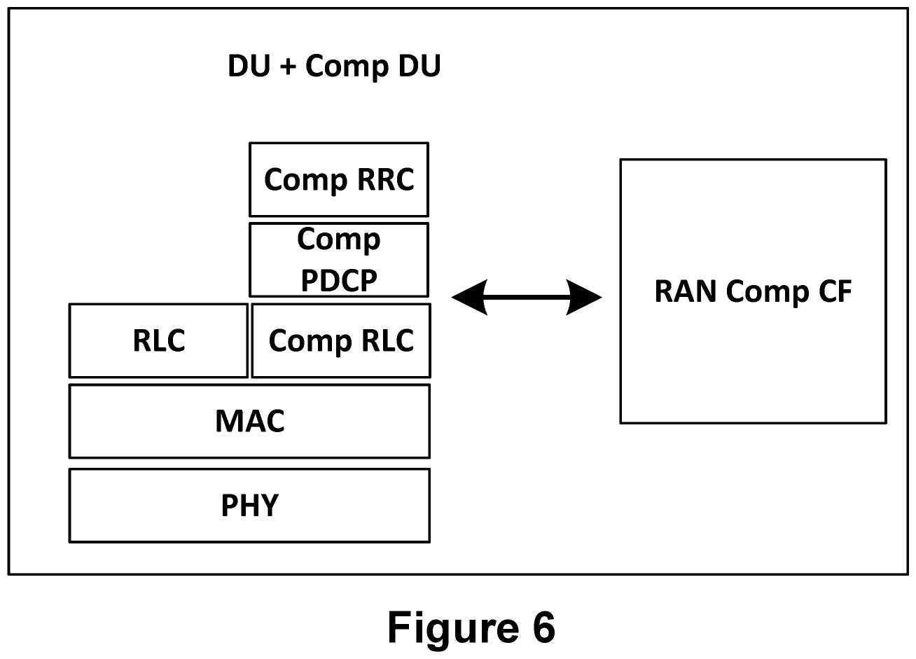

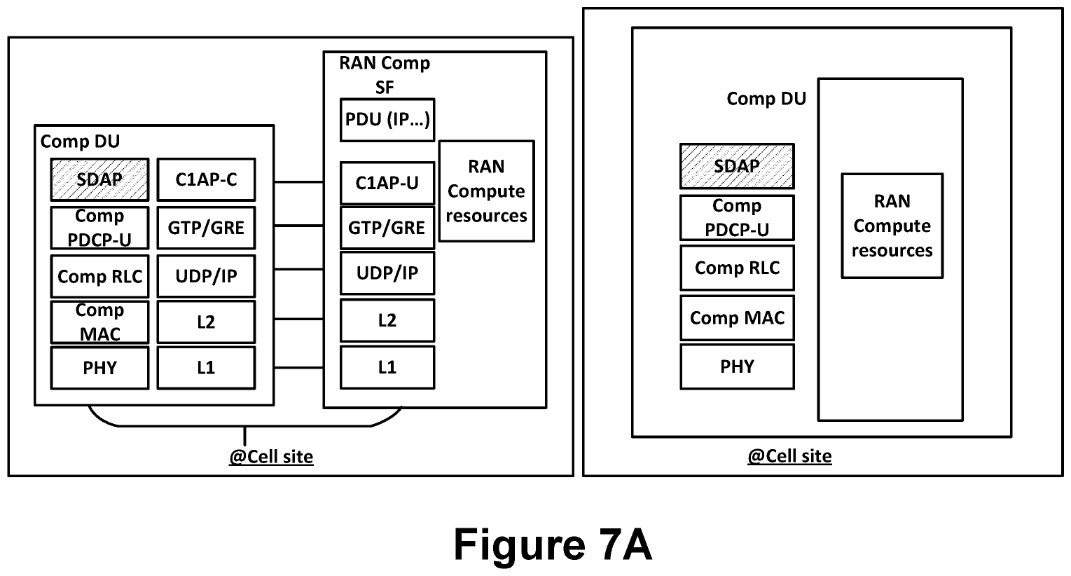

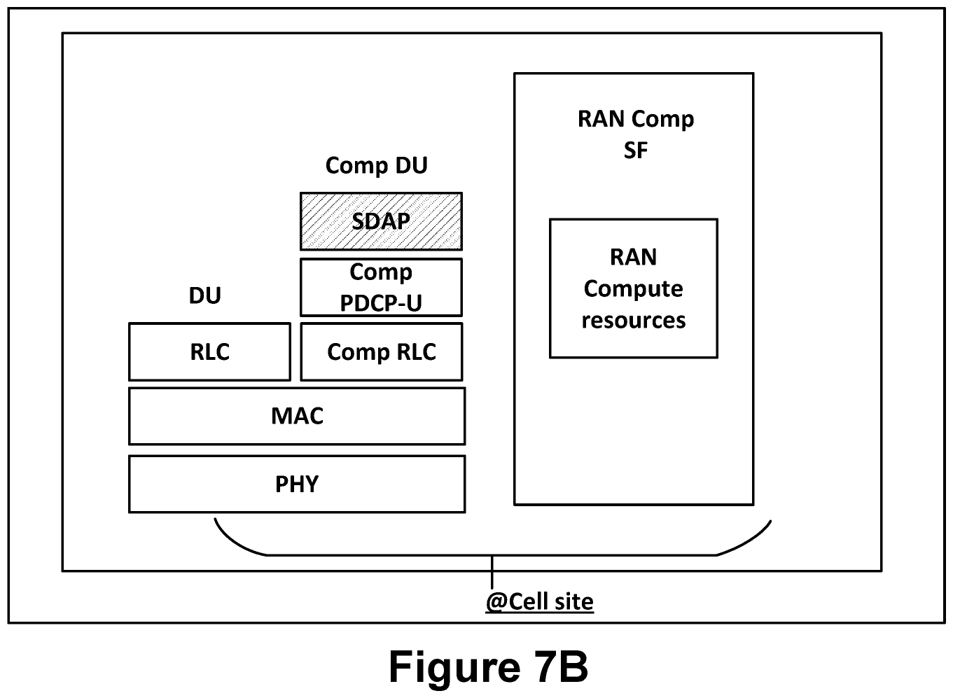

An example of the control plane architecture of the DU from the network perspective is shown in FIG. 6. Considering the service-level case, there is a separate control function that is used to control access to compute resources at a Service Function. Examples of the user plane architecture options of the compute DU from the network perspective are shown in FIGS. 7A and 7B.

The Compute DU may communicate with a RAN Comp CF using an explicit interface (shown at a high level in FIG. 6 and similar to FIG. 7A), however, it can be assumed that the most common architecture option is as shown here.

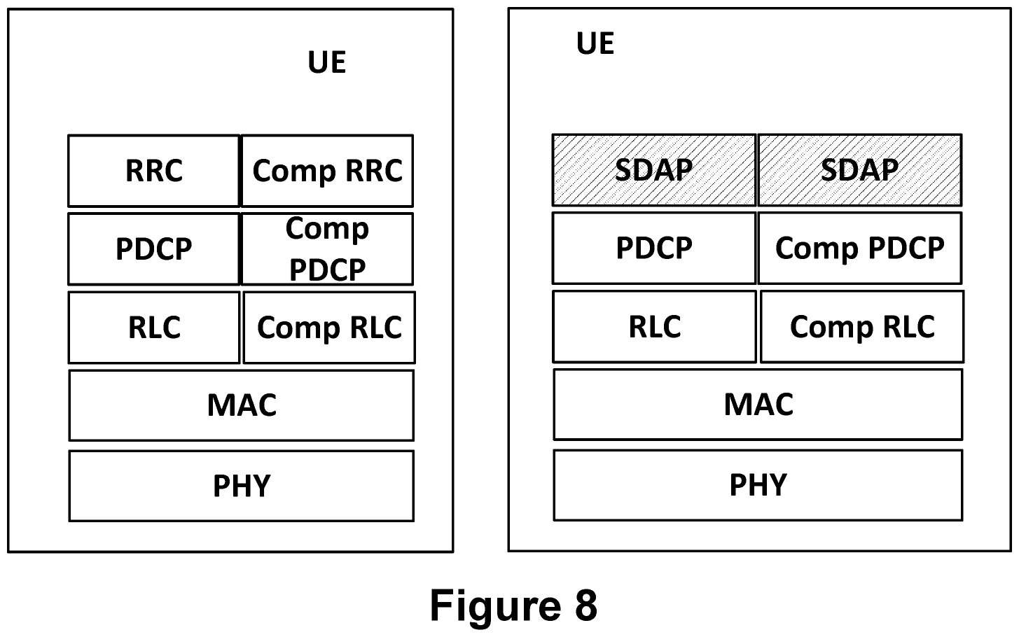

The UP architecture in FIGS. 7A-7C show examples of how the RAN compute resource is available at the cell site as part of the RAN compute DU node. FIG. 7C is a special example wherein the communication DU and the Comp DU share the same unit which is a possible deployment scenario as well. Similarly, the architecture from the UE perspective for both control plane and user plane are shown in FIG. 8. In some embodiments, it may be assumed that the PDCP, and RLC entities provide similar functions as for communication message transfer. There may be some changes needed in the MAC sublayer.

In the uplink user plane scenario, the SDAP sublayer handles RAN Compute QoS flows similar to regular QoS flows and passes the data to the Comp PDCP or PDCP entity accordingly.

### Embodiment (3) Protocol Stack Support for RAN Compute Offloading at the DU

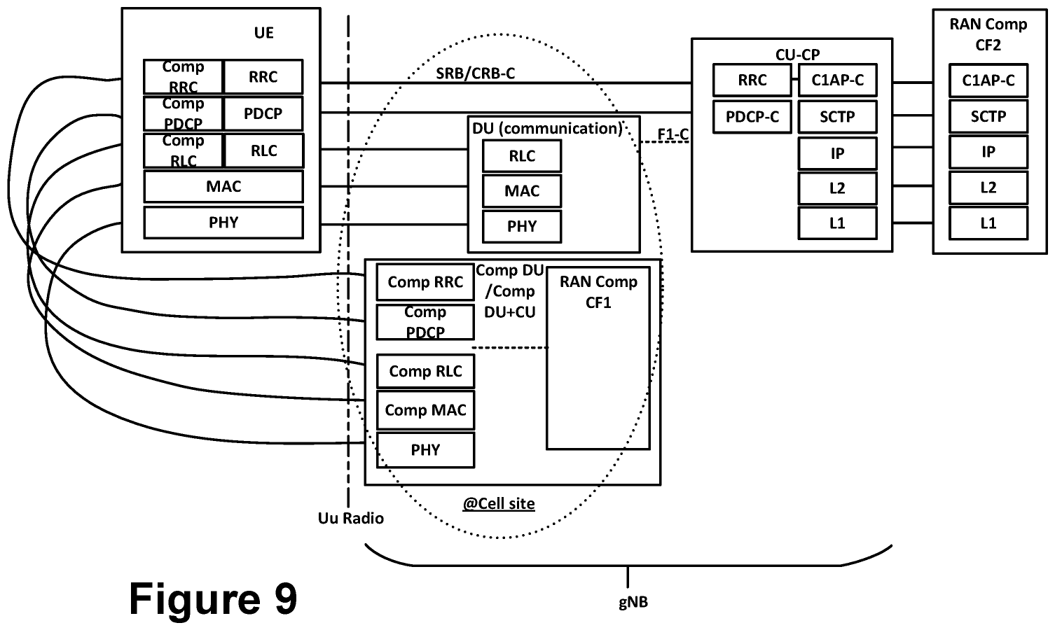

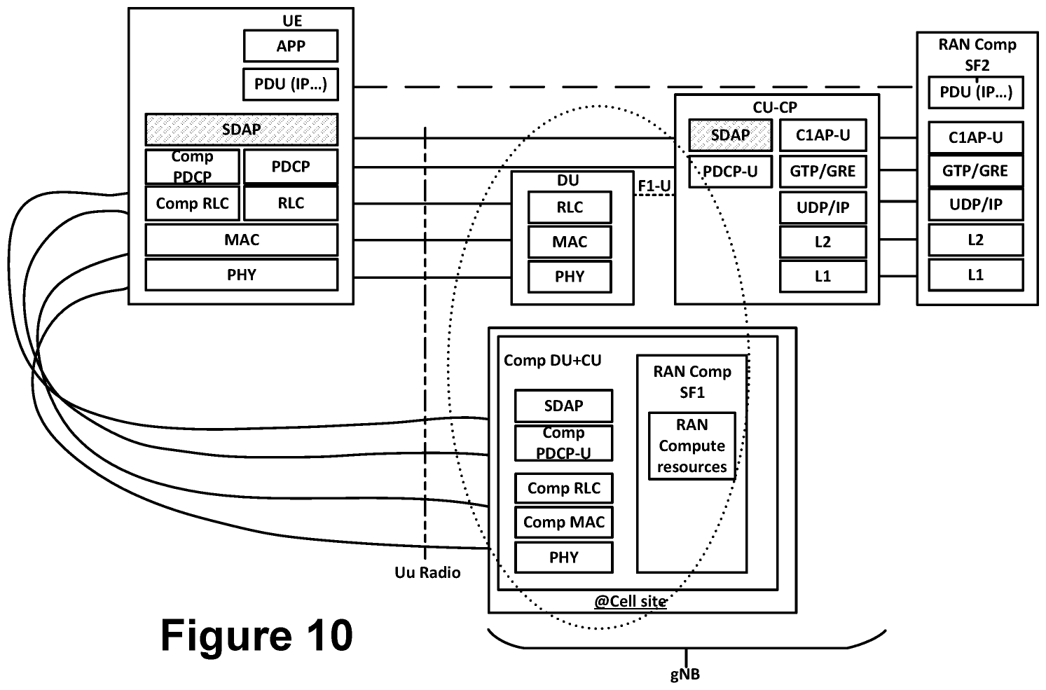

The protocol stack connection corresponding to the architecture options introduced in Embodiment 2 above are discussed here. In one example connection, the communication DU is independent of the Comp DU/complete Comp DU node and the CP protocol stack utilized is shown in FIG. 9. The corresponding CP protocol stack is shown in FIG. 10. Complete Comp DU node refers to the Comp DU which has compute resources access at resource-level and supports Comp RRC and also interfaces to CU.

A cell site may encompass one communication DU, one complete Comp DU as independent units e.g. separated and connected via an interface (that is to be defined) or housed together as one whole unit. In one example deployment, the RAN compute resource may be collocated within the complete Comp DU or connected via an interface showcased in the legacy architecture. The PHY and MAC from network perspective may be the same or different depending on whether the same unit houses both the communication and compute DU or different units do.

At the UE side, as can be seen, different RLC and PDCP entities support the communication and compute services (while the same MAC and PHY support both comm and comp services). The SDAP may be the same or different logical layer to support and map communication and compute QoS flows coming from upper layer. There may be an additional abstract logical layer between SDAP and application to support packet filtering but it is not shown in these diagrams for simplicity.

The primary aspect of note in the architecture is that of a new example control plane protocol called the Comp-RRC or Compute specific Radio Resource Control protocol to be defined at the UE and at the Complete Comp DU to support request/response exchanges of RAN compute services at the DU. The high-level functions of this protocol include but not limited to:
Necessary system information broadcast for radio frame timing, SFN.
Establishment, configuration, modification and release of compute radio bearers (signalling and compute data)
Security function
QoS support
Mobility support
Detection and recovery of radio link failure

### Embodiment (4) UE Access for RAN Compute Service

In some embodiments, a UE may perform initial access to the RAN Compute service at the DU after performing RACH procedure, using one of two options:

### Option a) Stateful Method Using Context-Based Mechanism

In this option, the UE initiates a request message to establish context at the network including UE context information, bearer establishment using the compute signaling radio bearer.

Using the dedicated compute data radio bearer already established and terminated at the Comp DU, the UE exchanges compute service user plane messages.

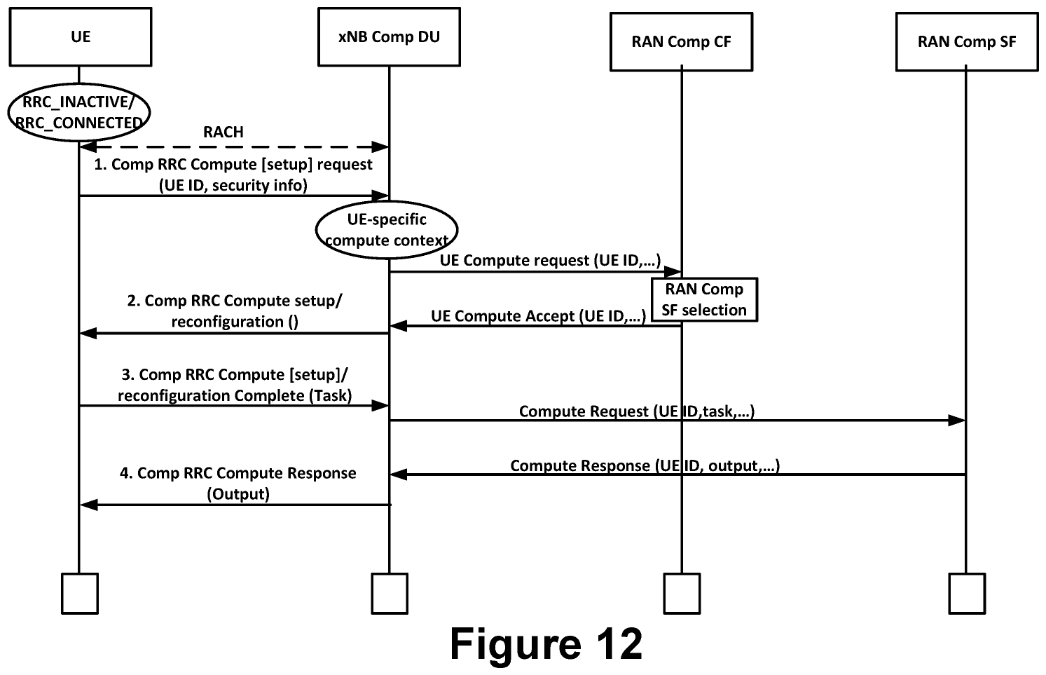

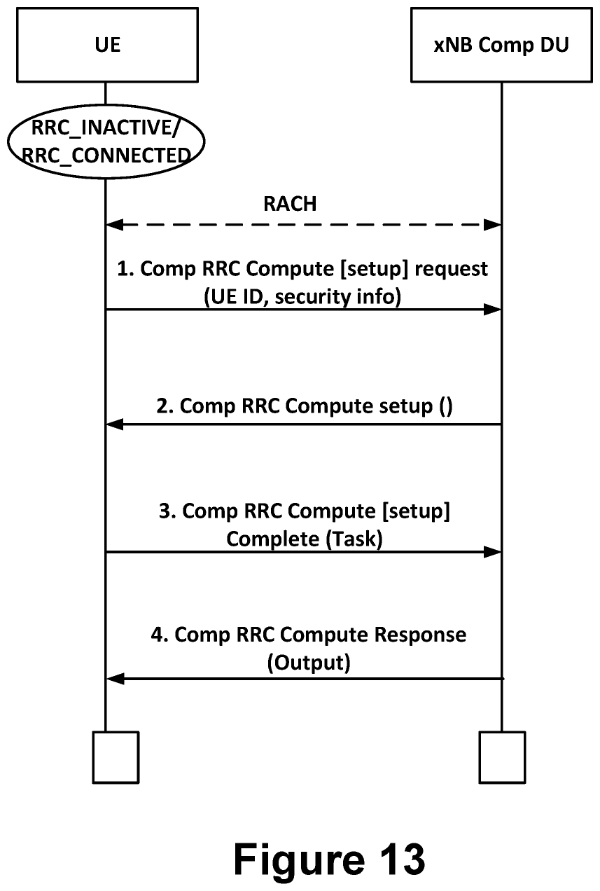

The Comp DU may reconfigure the bearer using Comp RRC at any time using dedicated signaling. An example set of actions taken by Comp DU for supporting uplink user plane request message is outlined below:
Reception of UE's compute task request
Handling UE's compute task request
   Passing the request to local RAN Comp SF upon security check (e.g. if associated UE's context is available or retrievable by the Comp DU; authentication or security check constitutes UE identification using its ID and security token); if Comp SF is already assigned or verifying with the RAN Comp CF to determine a suitable RAN Comp SF dynamically.
   Transmission of compute response as a downlink message
Updating the CU about UE's compute task request (if necessary) An example flow diagram for Comp RRC based RAN compute setup is shown in FIG. 12 and FIG. 13 (depending on whether option 1 or option 2 of compute resource is used). The steps are outlined below:
1) UE sends Comp RRC compute Setup request upon performing RACH with basic inputs such as UE ID and security information. It may also optionally provide any compute service relevant information (e.g. compute session ID, task ID, service ID, SF ID, etc.).
2) Based on the UE ID, gNB Comp DU looks up UE's compute context. If the context is found, it forwards the request to the relevant RAN Comp CF/SF or checks for resources. The gNB Comp DU may also perform reconfiguration or setup corresponding to compute service specific information to reconfigure RLC/PDCP.
3) UE sends Comp RRC compute Setup or reconfiguration complete corresponding to the received message from the Comp DU potentially along with the compute task user plane data encapsulated in a container.
4) The gNB DU extracts the task and forwards to the chosen RAN Comp SF (or uses the resource that is locally available at the DU if option 1 is supported) for computation and responds to the UE with the output received from the SF.

### Option b) Stateless or One-Shot Method Using Context-Free Mechanism

In this option, the UE sends a compute service request type of message including its ID and security information and the actual task information using default configuration towards the network. The network (e.g. the Comp DU and the RAN Comp SF) responds with the task response or results after checking UE's authorization/security/capability information. The RAN Comp CF may be consulted by the Comp DU as necessary to choose the suitable RAN Comp SF. At the same time, depending on how large a packet can be sent in the first message after initial RACH preamble transmission, there may be some limitations to this option (unless UE ID information is carried in the header and multiple messages may then be sent).

In one example, the UE's access to the RAN compute service is considered independent of the UE's communication RRC state. As long as the UE is in-coverage and camped in the cell successfully, has been configured either using dedicated signaling (when it was RRC_CONNECTED) or using system information, and it supports the compute capability, the UE is then able to access the compute service at the DU by sending task requests.

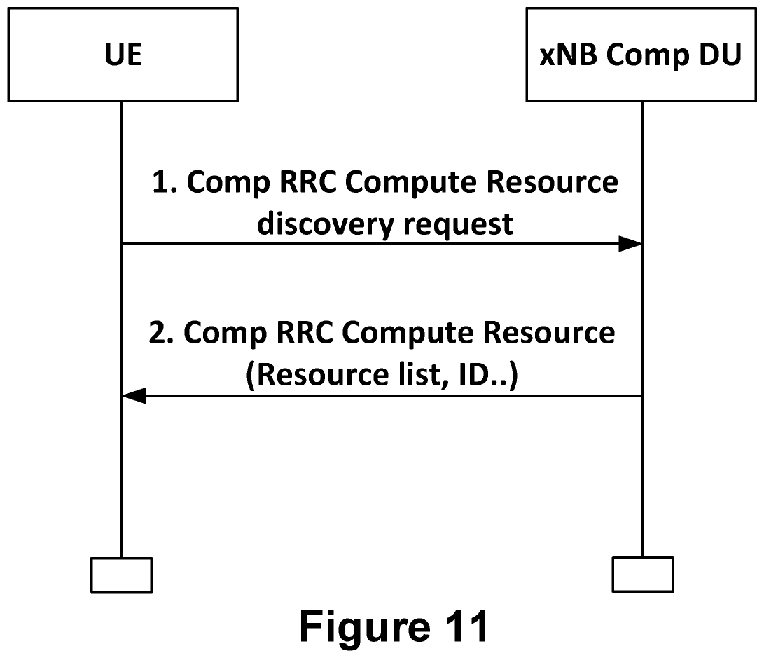

In another example, the UE may discover resources at the gNB Comp DU by sending resource discovery request message prior to sending task request. The gNB Comp DU responds with a list of available resources and the corresponding ID to access the resource accordingly. The UE could use Comp RRC messages to perform discovery. An example of this is represented in FIG. 11.

Interaction with CU

In one example, using bearer modification procedures, the compute radio bearer at the Comp DU node should be able to be relocated to the CU-UP if necessary. In this process, the UE may or may not perform intra-DU mobility (e.g. move from Comp DU to communication DU, depending on configuration).

The interaction of UE's RAN Compute access at the DU with the DRX sleep mechanism (e.g. when in inactive or idle or connected) and any potential enhancements to the RACH resource allocation are contemplated. However, for the description of various embodiments herein, it may be assumed that the MAC entity is restarted when a new compute request comes from the upper layers/Comp RLC.

### Embodiment (5) UE Contexts at the Network

To support the RAN compute service at the DU, it can be assumed the following contexts are maintained at a compute-only state, or at COMPUTE_LOCAL_READY state:

### a) Compute DU Node UE Context

A Compute DU node UE context is a block of information stored at the Comp DU (or complete Comp DU) node associated to one UE. This context contains the necessary information required to maintain/support RAN Compute services towards the UE. It includes at least the UE ID, compute at DU related security information, UE compute capability information, compute slice information and the identities of UE-associated specific end-to-end logical connection/interface information (e.g. UE to RAN Comp SF). In one example, the UE can be defined to be in Compute-Ready state or COMPUTE_LOCAL_READY state or similar state when the Compute DU node UE context is established. This context may also include the information of the radio bearer context as described below.

### b) Optional Bearer Context Per UE

A Compute bearer context is a block of information in the complete Comp DU node associated to one UE that is used for communication between control plane and user plane parts of the DU. It may include information about compute radio bearers, compute sessions, transport information and compute QoS flows associated to the UE. This is needed to maintain compute related UP services towards the UE.

In one extended example, the contexts may be maintained in two ways: (1) a dynamic manner: wherein only the Comp DU node stores the UE context; or (2) a static manner: wherein the Comp DU node UE context is distributed to all the DUs in the RNA or at least belonging to the same CU.

In another extended example, the UE can specify where the computing context can be stored by subscription. In yet another extended example, timers can be set up and started/restarted when the context is created and modified to determine the lifetime of the Compute UE context, especially for the statically stored scenario. Comp DU and CU may run different timers and when the timer expires, new reconfiguration/configuration/request messages can be exchanged to set up the context again.

### Systems and Implementations

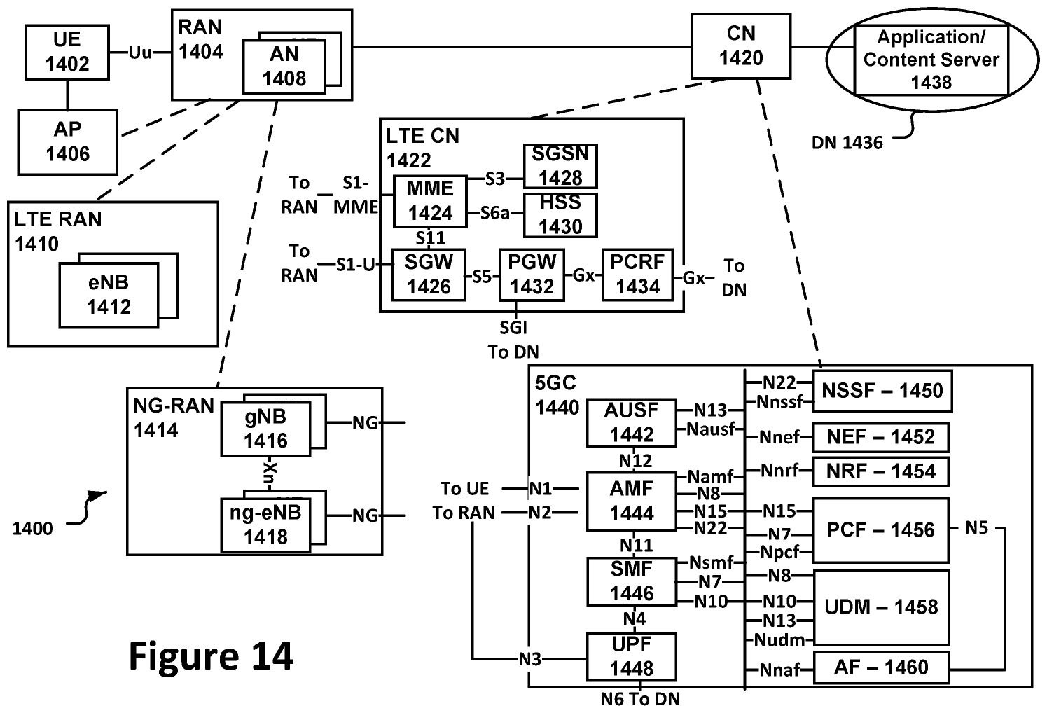

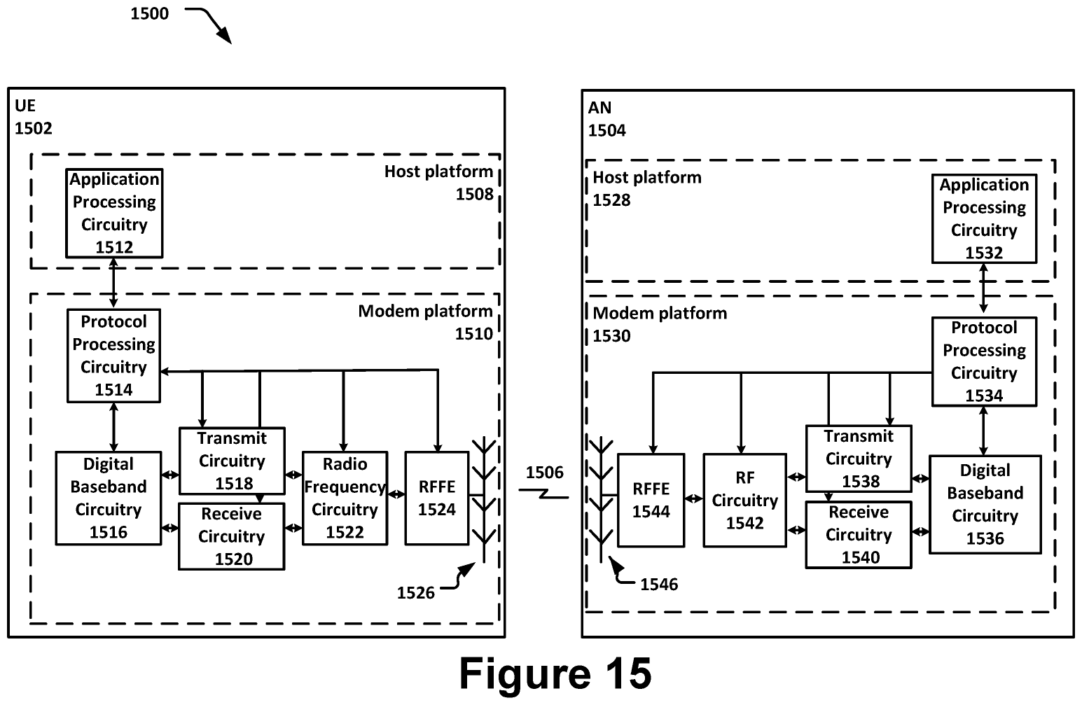

FIGS. 14-15 illustrate various systems, devices, and components that may implement aspects of disclosed embodiments.

FIG. 14 illustrates a network 1400 in accordance with various embodiments. The network 1400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1400 may include a UE 1402, which may include any mobile or non-mobile computing device designed to communicate with a RAN 1404 via an over-the-air connection. The UE 1402 may be communicatively coupled with the RAN 1404 by a Uu interface. The UE 1402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1402 may additionally communicate with an AP 1406 via an over-the-air connection. The AP 1406 may manage a WLAN connection, which may serve to offload some/all network traffic from the RAN 1404. The connection between the UE 1402 and the AP 1406 may be consistent with any IEEE 802.11 protocol, wherein the AP 1406 could be a wireless fidelity (Wi-Fi®) router. In some embodiments, the UE 1402, RAN 1404, and AP 1406 may utilize cellular-WLAN aggregation (for example, LWA/LWIP). Cellular-WLAN aggregation may involve the UE 1402 being configured by the RAN 1404 to utilize both cellular radio resources and WLAN resources.

The RAN 1404 may include one or more access nodes, for example, AN 1408. AN 1408 may terminate air-interface protocols for the UE 1402 by providing access stratum protocols including RRC, PDCP, RLC, MAC, and L1 protocols. In this manner, the AN 1408 may enable data/voice connectivity between CN 1420 and the UE 1402. In some embodiments, the AN 1408 may be implemented in a discrete device or as one or more software entities running on server computers as part of, for example, a virtual network, which may be referred to as a CRAN or virtual baseband unit pool. The AN 1408 be referred to as a BS, gNB, RAN node, eNB, ng-eNB, NodeB, RSU, TRxP, TRP, etc. The AN 1408 may be a macrocell base station or a low power base station for providing femtocells, picocells or other like cells having smaller coverage areas, smaller user capacity, or higher bandwidth compared to macrocells.

In embodiments in which the RAN 1404 includes a plurality of ANs, they may be coupled with one another via an X2 interface (if the RAN 1404 is an LTE RAN) or an Xn interface (if the RAN 1404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1404 may each manage one or more cells, cell groups, component carriers, etc. to provide the UE 1402 with an air interface for network access. The UE 1402 may be simultaneously connected with a plurality of cells provided by the same or different ANs of the RAN 1404. For example, the UE 1402 and RAN 1404 may use carrier aggregation to allow the UE 1402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1402 or AN 1408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1404 may be an LTE RAN 1410 with eNBs, for example, eNB 1412. The LTE RAN 1410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1404 may be an NG-RAN 1414 with gNBs, for example, gNB 1416, or ng-eNBs, for example, ng-eNB 1418. The gNB 1416 may connect with 5G-enabled UEs using a 5G NR interface. The gNB 1416 may connect with a 5G core through an NG interface, which may include an N2 interface or an N3 interface. The ng-eNB 1418 may also connect with the 5G core through an NG interface, but may connect with a UE via an LTE air interface. The gNB 1416 and the ng-eNB 1418 may connect with each other over an Xn interface.

In some embodiments, the NG interface may be split into two parts, an NG user plane (NG-U) interface, which carries traffic data between the nodes of the NG-RAN 1414 and a UPF 1448 (e.g., N3 interface), and an NG control plane (NG-C) interface, which is a signaling interface between the nodes of the NG-RAN 1414 and an AMF 1444 (e.g., N2 interface).

The NG-RAN 1414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1402 can be configured with multiple BWPs where each BWP configuration has a different SCS. When a BWP change is indicated to the UE 1402, the SCS of the transmission is changed as well. Another use case example of BWP is related to power saving. In particular, multiple BWPs can be configured for the UE 1402 with different amount of frequency resources (for example, PRBs) to support data transmission under different traffic loading scenarios. A BWP containing a smaller number of PRBs can be used for data transmission with small traffic load while allowing power saving at the UE 1402 and in some cases at the gNB 1416. A BWP containing a larger number of PRBs can be used for scenarios with higher traffic load.

The RAN 1404 is communicatively coupled to CN 1420 that includes network elements to provide various functions to support data and telecommunications services to customers/subscribers (for example, users of UE 1402). The components of the CN 1420 may be implemented in one physical node or separate physical nodes. In some embodiments, NFV may be utilized to virtualize any or all of the functions provided by the network elements of the CN 1420 onto physical compute/storage resources in servers, switches, etc. A logical instantiation of the CN 1420 may be referred to as a network slice, and a logical instantiation of a portion of the CN 1420 may be referred to as a network sub-slice.

In some embodiments, the CN 1420 may be an LTE CN 1422, which may also be referred to as an EPC. The LTE CN 1422 may include MME 1424, SGW 1426, SGSN 1428, HSS 1430, PGW 1432, and PCRF 1434 coupled with one another over interfaces (or “reference points”) as shown. Functions of the elements of the LTE CN 1422 may be briefly introduced as follows.

The MME 1424 may implement mobility management functions to track a current location of the UE 1402 to facilitate paging, bearer activation/deactivation, handovers, gateway selection, authentication, etc.

The SGW 1426 may terminate an S1 interface toward the RAN and route data packets between the RAN and the LTE CN 1422. The SGW 1426 may be a local mobility anchor point for inter-RAN node handovers and also may provide an anchor for inter-3GPP mobility. Other responsibilities may include lawful intercept, charging, and some policy enforcement.

The SGSN 1428 may track a location of the UE 1402 and perform security functions and access control. In addition, the SGSN 1428 may perform inter-EPC node signaling for mobility between different RAT networks; PDN and S-GW selection as specified by MME 1424; MME selection for handovers; etc. The S3 reference point between the MME 1424 and the SGSN 1428 may enable user and bearer information exchange for inter-3GPP access network mobility in idle/active states.

The HSS 1430 may include a database for network users, including subscription-related information to support the network entities' handling of communication sessions. The HSS 1430 can provide support for routing/roaming, authentication, authorization, naming/addressing resolution, location dependencies, etc. An S6a reference point between the HSS 1430 and the MME 1424 may enable transfer of subscription and authentication data for authenticating/authorizing user access to the LTE CN 1420.

The PGW 1432 may terminate an SGi interface toward a data network (DN) 1436 that may include an application/content server 1438. The PGW 1432 may route data packets between the LTE CN 1422 and the data network 1436. The PGW 1432 may be coupled with the SGW 1426 by an S5 reference point to facilitate user plane tunneling and tunnel management. The PGW 1432 may further include a node for policy enforcement and charging data collection (for example, PCEF). Additionally, the SGi reference point between the PGW 1432 and the data network 1436 may be an operator external public, a private PDN, or an intra-operator packet data network, for example, for provision of IMS services. The PGW 1432 may be coupled with a PCRF 1434 via a Gx reference point.

The PCRF 1434 is the policy and charging control element of the LTE CN 1422. The PCRF 1434 may be communicatively coupled to the app/content server 1438 to determine appropriate QoS and charging parameters for service flows. The PCRF 1432 may provision associated rules into a PCEF (via Gx reference point) with appropriate TFT and QCI.

In some embodiments, the CN 1420 may be a 5GC 1440. The 5GC 1440 may include an AUSF 1442, AMF 1444, SMF 1446, UPF 1448, NSSF 1450, NEF 1452, NRF 1454, PCF 1456, UDM 1458, and AF 1460 coupled with one another over interfaces (or “reference points”) as shown. Functions of the elements of the 5GC 1440 may be briefly introduced as follows.

The AUSF 1442 may store data for authentication of UE 1402 and handle authentication-related functionality. The AUSF 1442 may facilitate a common authentication framework for various access types. In addition to communicating with other elements of the 5GC 1440 over reference points as shown, the AUSF 1442 may exhibit an Nausf service-based interface.

The AMF 1444 may allow other functions of the 5GC 1440 to communicate with the UE 1402 and the RAN 1404 and to subscribe to notifications about mobility events with respect to the UE 1402. The AMF 1444 may be responsible for registration management (for example, for registering UE 1402), connection management, reachability management, mobility management, lawful interception of AMF-related events, and access authentication and authorization. The AMF 1444 may provide transport for SM messages between the UE 1402 and the SMF 1446, and act as a transparent proxy for routing SM messages. AMF 1444 may also provide transport for SMS messages between UE 1402 and an SMSF. AMF 1444 may interact with the AUSF 1442 and the UE 1402 to perform various security anchor and context management functions. Furthermore, AMF 1444 may be a termination point of a RAN CP interface, which may include or be an N2 reference point between the RAN 1404 and the AMF 1444; and the AMF 1444 may be a termination point of NAS (N1) signaling, and perform NAS ciphering and integrity protection. AMF 1444 may also support NAS signaling with the UE 1402 over an N3 IWF interface.

The SMF 1446 may be responsible for SM (for example, session establishment, tunnel management between UPF 1448 and AN 1408); UE IP address allocation and management (including optional authorization); selection and control of UP function; configuring traffic steering at UPF 1448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1444 over N2 to AN 1408; and determining SSC mode of a session. SM may refer to management of a PDU session, and a PDU session or “session” may refer to a PDU connectivity service that provides or enables the exchange of PDUs between the UE 1402 and the data network 1436.

The UPF 1448 may act as an anchor point for intra-RAT and inter-RAT mobility, an external PDU session point of interconnect to data network 1436, and a branching point to support multi-homed PDU session. The UPF 1448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1448 may include an uplink classifier to support routing traffic flows to a data network.

The NSSF 1450 may select a set of network slice instances serving the UE 1402. The NSSF 1450 may also determine allowed NSSAI and the mapping to the subscribed S-NSSAIs, if needed. The NSSF 1450 may also determine the AMF set to be used to serve the UE 1402, or a list of candidate AMFs based on a suitable configuration and possibly by querying the NRF 1454. The selection of a set of network slice instances for the UE 1402 may be triggered by the AMF 1444 with which the UE 1402 is registered by interacting with the NSSF 1450, which may lead to a change of AMF. The NSSF 1450 may interact with the AMF 1444 via an N22 reference point; and may communicate with another NSSF in a visited network via an N31 reference point (not shown). Additionally, the NSSF 1450 may exhibit an Nnssf service-based interface.

The NEF 1452 may securely expose services and capabilities provided by 3GPP network functions for third party, internal exposure/re-exposure, AFs (e.g., AF 1460), edge computing or fog computing systems, etc. In such embodiments, the NEF 1452 may authenticate, authorize, or throttle the AFs. NEF 1452 may also translate information exchanged with the AF 1460 and information exchanged with internal network functions. For example, the NEF 1452 may translate between an AF-Service-Identifier and an internal 5GC information. NEF 1452 may also receive information from other NFs based on exposed capabilities of other NFs. This information may be stored at the NEF 1452 as structured data, or at a data storage NF using standardized interfaces. The stored information can then be re-exposed by the NEF 1452 to other NFs and AFs, or used for other purposes such as analytics. Additionally, the NEF 1452 may exhibit an Nnef service-based interface.

The NRF 1454 may support service discovery functions, receive NF discovery requests from NF instances, and provide the information of the discovered NF instances to the NF instances. NRF 1454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1454 may exhibit the Nnrf service-based interface.

The PCF 1456 may provide policy rules to control plane functions to enforce them, and may also support unified policy framework to govern network behavior. The PCF 1456 may also implement a front end to access subscription information relevant for policy decisions in a UDR of the UDM 1458. In addition to communicating with functions over reference points as shown, the PCF 1456 exhibit an Npcf service-based interface.

The UDM 1458 may handle subscription-related information to support the network entities' handling of communication sessions, and may store subscription data of UE 1402. For example, subscription data may be communicated via an N8 reference point between the UDM 1458 and the AMF 1444. The UDM 1458 may include two parts, an application front end and a UDR. The UDR may store subscription data and policy data for the UDM 1458 and the PCF 1456, and/or structured data for exposure and application data (including PFDs for application detection, application request information for multiple UEs 1402) for the NEF 1452. The Nudr service-based interface may be exhibited by the UDR 221 to allow the UDM 1458, PCF 1456, and NEF 1452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1458 may exhibit the Nudm service-based interface.

The AF 1460 may provide application influence on traffic routing, provide access to NEF, and interact with the policy framework for policy control.

In some embodiments, the 5GC 1440 may enable edge computing by selecting operator/3^{rd} party services to be geographically close to a point that the UE 1402 is attached to the network. This may reduce latency and load on the network. To provide edge-computing implementations, the 5GC 1440 may select a UPF 1448 close to the UE 1402 and execute traffic steering from the UPF 1448 to data network 1436 via the N6 interface. This may be based on the UE subscription data, UE location, and information provided by the AF 1460. In this way, the AF 1460 may influence UPF (re)selection and traffic routing. Based on operator deployment, when AF 1460 is considered to be a trusted entity, the network operator may permit AF 1460 to interact directly with relevant NFs. Additionally, the AF 1460 may exhibit an Naf service-based interface.

The data network 1436 may represent various network operator services, Internet access, or third party services that may be provided by one or more servers including, for example, application/content server 1438.

FIG. 15 schematically illustrates a wireless network 1500 in accordance with various embodiments. The wireless network 1500 may include a UE 1502 in wireless communication with an AN 1504. The UE 1502 and AN 1504 may be similar to, and substantially interchangeable with, like-named components described elsewhere herein.

The UE 1502 may be communicatively coupled with the AN 1504 via connection 1506. The connection 1506 is illustrated as an air interface to enable communicative coupling, and can be consistent with cellular communications protocols such as an LTE protocol or a 5G NR protocol operating at mmWave or sub-6 GHz frequencies.

The UE 1502 may include a host platform 1508 coupled with a modem platform 1510. The host platform 1508 may include application processing circuitry 1512, which may be coupled with protocol processing circuitry 1514 of the modem platform 1510. The application processing circuitry 1512 may run various applications for the UE 1502 that source/sink application data. The application processing circuitry 1512 may further implement one or more layer operations to transmit/receive application data to/from a data network. These layer operations may include transport (for example UDP) and Internet (for example, IP) operations

The protocol processing circuitry 1514 may implement one or more of layer operations to facilitate transmission or reception of data over the connection 1506. The layer operations implemented by the protocol processing circuitry 1514 may include, for example, MAC, RLC, PDCP, RRC and NAS operations.

The modem platform 1510 may further include digital baseband circuitry 1516 that may implement one or more layer operations that are “below” layer operations performed by the protocol processing circuitry 1514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1510 may further include transmit circuitry 1518, receive circuitry 1520, RF circuitry 1522, and RF front end (RFFE) 1524, which may include or connect to one or more antenna panels 1526. Briefly, the transmit circuitry 1518 may include a digital-to-analog converter, mixer, intermediate frequency (IF) components, etc.; the receive circuitry 1520 may include an analog-to-digital converter, mixer, IF components, etc.; the RF circuitry 1522 may include a low-noise amplifier, a power amplifier, power tracking components, etc.; RFFE 1524 may include filters (for example, surface/bulk acoustic wave filters), switches, antenna tuners, beamforming components (for example, phase-array antenna components), etc. The selection and arrangement of the components of the transmit circuitry 1518, receive circuitry 1520, RF circuitry 1522, RFFE 1524, and antenna panels 1526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1514 may include one or more instances of control circuitry (not shown) to provide control functions for the transmit/receive components.

A UE reception may be established by and via the antenna panels 1526, RFFE 1524, RF circuitry 1522, receive circuitry 1520, digital baseband circuitry 1516, and protocol processing circuitry 1514. In some embodiments, the antenna panels 1526 may receive a transmission from the AN 1504 by receive-beamforming signals received by a plurality of antennas/antenna elements of the one or more antenna panels 1526.

A UE transmission may be established by and via the protocol processing circuitry 1514, digital baseband circuitry 1516, transmit circuitry 1518, RF circuitry 1522, RFFE 1524, and antenna panels 1526. In some embodiments, the transmit components of the UE 1504 may apply a spatial filter to the data to be transmitted to form a transmit beam emitted by the antenna elements of the antenna panels 1526.

Similar to the UE 1502, the AN 1504 may include a host platform 1528 coupled with a modem platform 1530. The host platform 1528 may include application processing circuitry 1532 coupled with protocol processing circuitry 1534 of the modem platform 1530. The modem platform may further include digital baseband circuitry 1536, transmit circuitry 1538, receive circuitry 1540, RF circuitry 1542, RFFE circuitry 1544, and antenna panels 1546. The components of the AN 1504 may be similar to and substantially interchangeable with like-named components of the UE 1502. In addition to performing data transmission/reception as described above, the components of the AN 1508 may perform various logical functions that include, for example, RNC functions such as radio bearer management, uplink and downlink dynamic radio resource management, and data packet scheduling.

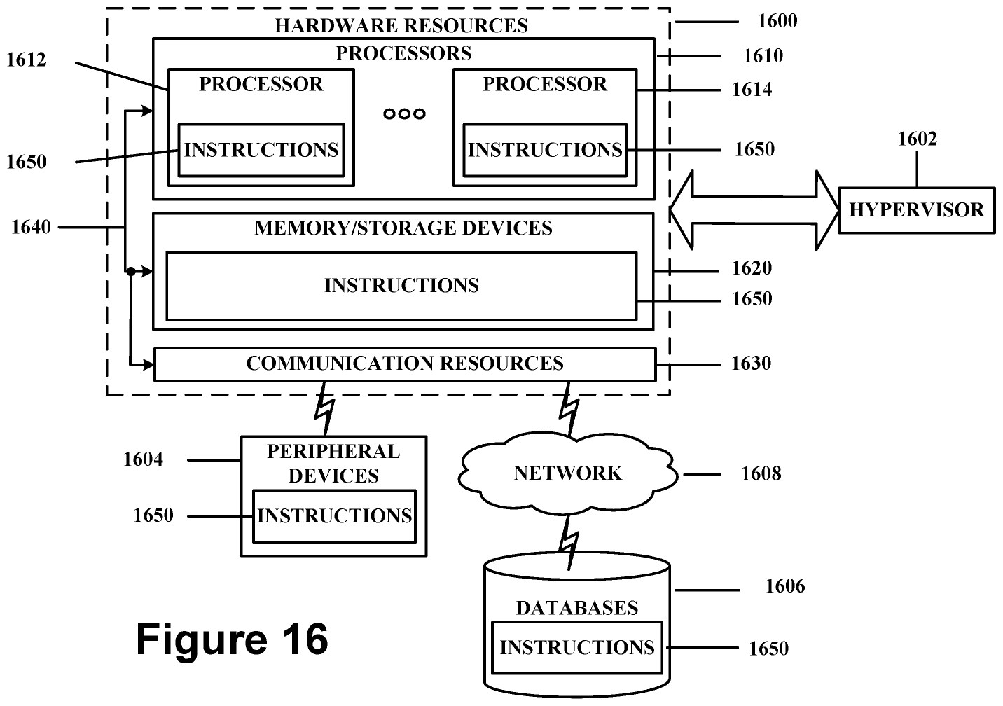

FIG. 16 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1600 including one or more processors (or processor cores) 1610, one or more memory/storage devices 1620, and one or more communication resources 1630, each of which may be communicatively coupled via a bus 1640 or other interface circuitry. For embodiments where node virtualization (e.g., NFV) is utilized, a hypervisor 1602 may be executed to provide an execution environment for one or more network slices/sub-slices to utilize the hardware resources 1600.

The processors 1610 may include, for example, a processor 1612 and a processor 1614. The processors 1610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1620 may include main memory, disk storage, or any suitable combination thereof. The memory/storage devices 1620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1630 may include interconnection or network interface controllers, components, or other suitable devices to communicate with one or more peripheral devices 1604 or one or more databases 1606 or other network elements via a network 1608. For example, the communication resources 1630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1650 may comprise software, a program, an application, an applet, an app, or other executable code for causing at least any of the processors 1610 to perform any one or more of the methodologies discussed herein. The instructions 1650 may reside, completely or partially, within at least one of the processors 1610 (e.g., within the processor's cache memory), the memory/storage devices 1620, or any suitable combination thereof. Furthermore, any portion of the instructions 1650 may be transferred to the hardware resources 1600 from any combination of the peripheral devices 1604 or the databases 1606. Accordingly, the memory of processors 1610, the memory/storage devices 1620, the peripheral devices 1604, and the databases 1606 are examples of computer-readable and machine-readable media.

### Example Procedures

In some embodiments, the electronic device(s), network(s), system(s), chip(s) or component(s), or portions or implementations thereof, of FIGS. 14-16, or some other figure herein, may be configured to perform one or more processes, techniques, or methods as described herein, or portions thereof.

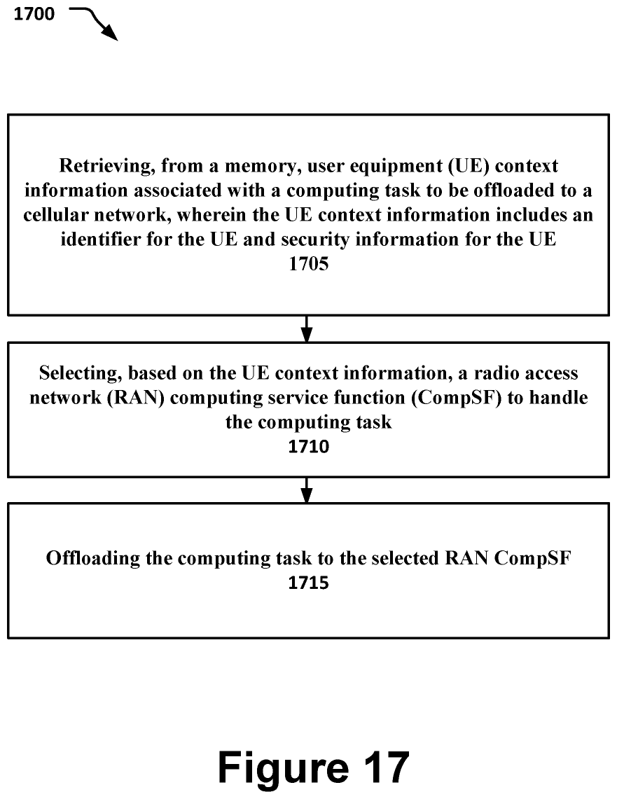

One such process is depicted in FIG. 17. In this example, process 1700 includes, at 1705, retrieving, from a memory, user equipment (UE) context information associated with a computing task to be offloaded to a cellular network, wherein the UE context information includes an identifier for the UE and security information for the UE. The process further includes, at 1710, selecting, based on the UE context information, a radio access network (RAN) computing service function (CompSF) to handle the computing task. The process further includes, at 1715, offloading the computing task to the selected RAN CompSF.

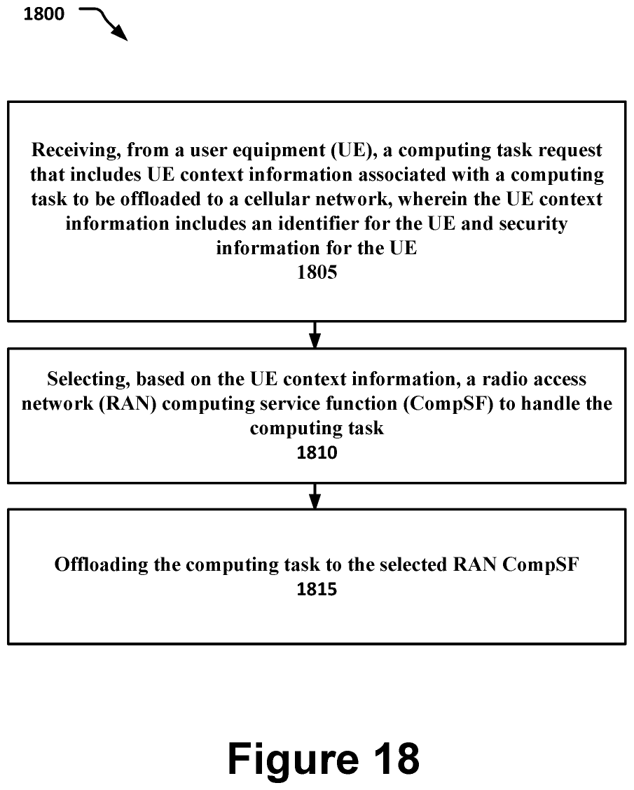

Another such process is depicted in FIG. 18. In this example, process 1800 includes, at 1805, receiving, from a user equipment (UE), a computing task request that includes UE context information associated with a computing task to be offloaded to a cellular network, wherein the UE context information includes an identifier for the UE and security information for the UE. The process further includes, at 1810, selecting, based on the UE context information, a radio access network (RAN) computing service function (CompSF) to handle the computing task. The process further includes, at 1815, offloading the computing task to the selected RAN CompSF.

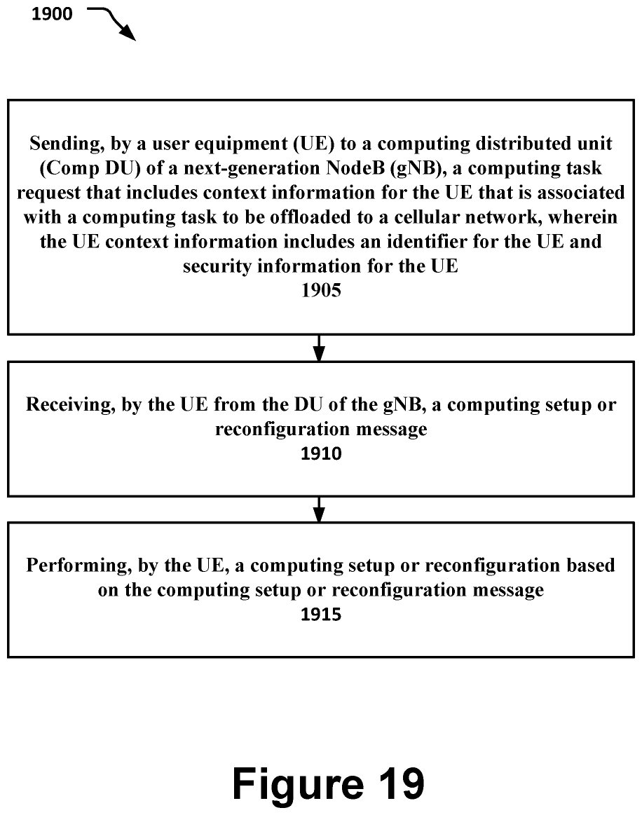

Another such process is depicted in FIG. 19. In this example, process 1900 includes, at 1905, sending, by a user equipment (UE) to a computing distributed unit (Comp DU) of a next-generation NodeB (gNB), a computing task request that includes context information for the UE that is associated with a computing task to be offloaded to a cellular network, wherein the UE context information includes an identifier for the UE and security information for the UE. The process further includes, at 1910, receiving, by the UE from the DU of the gNB, a computing setup or reconfiguration message. The process further includes, at 1915, performing, by the UE, a computing setup or reconfiguration based on the computing setup or reconfiguration message.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method in which a UE has a compute task to be offloaded to the RAN to support a given computation request and respond with corresponding message.

Example 2 may include the method of example 1 or some other example herein, wherein the RAN Comp DU (e.g. gNB/xNB with compute support) supports compute resources managed as separate functions such as RAN Compute CF (for control) and RAN Compute SF (service function) for service-level compute or by itself as resource-level compute.

Example 3 may include the method of example 2 or some other example herein, wherein the Comp DU provides information of its capability to support compute at resource-level or service-level in dedicated or broadcast signalling.

Example 4 may include the method of example 1 or some other example herein, wherein the UE supports Compute RRC signalling and corresponding SDAP, Comp PDCP, Comp RLC entities to communicate with the Comp DU for compute purposes in control plane and user plane.

Example 5 may include the method of example 2 or some other example herein, wherein the network supports Compute RRC signalling at the DU to serve the UEs of example 1.

Example 6 may include the method of example 2 or some other example herein, wherein the communication and compute entities are collocated at the DU and may support an interface between them and there may also be an explicit interface between Comp DU and CU or through the communication DU.

Example 7 may include the method of examples 4 and 5 or some other example herein, wherein the comp RRC supports the following functions:
Necessary system information broadcast for radio frame timing, SFN.
Establishment, configuration, modification and release of compute radio bearers (signalling and compute data)
Security function
QoS support
Mobility support
Detection and recovery of radio link failure

Example 8 may include the method of example 7 or some other example herein, wherein the Comp RRC signalling is used to receive a given UE's compute task, and perform security check, reconfigure compute radio bearers and respond with compute results in a stateful or stateless manner.

Example 9 may include the method of examples 4 and 5 or some other example herein, wherein the Comp RRC is used to perform discovery of resources available at the xNB.

Example 10 may include the method of example 2 or some other example herein, wherein the Comp DU could maintain UE context dynamically or statically by distributing it to all DUs within the RNA or cells belonging to the same CU.

Example X1 includes an apparatus comprising:
memory to store user equipment (UE) context information associated with a computing task to be offloaded to a cellular network; and
processing circuitry, coupled with the memory, to:
   retrieve the UE context from the memory, wherein the UE context information includes an identifier for the UE and security information for the UE;
   select, based on the UE context information, a radio access network (RAN) computing service function (CompSF) to handle the computing task; and
   offload the computing task to the selected RAN CompSF.

Example X2 includes the apparatus of example X1 or some other example herein, wherein the UE context information is received via computing task request received from the UE.

Example X3 includes the apparatus of example X2 or some other example herein, wherein the computing task request is received via radio resource control (RRC) signaling.

Example X4 includes the apparatus of example X2 or some other example herein, wherein the computing task request includes computing service information that includes one or more of a computing session identifier, a task identifier, a service identifier, or a service function (SF) identifier.

Example X5 includes the apparatus of example X1 or some other example herein, wherein selecting the RAN CompSF includes determining one or more resources associated with the RAN CompSF.

Example X6 includes the apparatus of example X1 or some other example herein, wherein the processing circuitry is further to provide computing offloading capability information to the UE.

Example X7 includes the apparatus of example X6 or some other example herein, wherein the computing offloading capability information is provided to the UE via radio resource control (RRC) signaling.

Example X8 includes the apparatus of any of examples X1-X7 or some other example herein, wherein the apparatus includes a next-generation NodeB (gNB), or portion thereof, that includes a computing distributed unit (DU).

Example X9 includes one or more computer-readable media storing instructions that, when executed by one or more processors, cause a next-generation NodeB (gNB) to:
receive, from a user equipment (UE), a computing task request that includes UE context information associated with a computing task to be offloaded to a cellular network, wherein the UE context information includes an identifier for the UE and security information for the UE;
select, based on the UE context information, a radio access network (RAN) computing service function (CompSF) to handle the computing task; and
offload the computing task to the selected RAN CompSF.

Example X10 includes the one or more computer-readable media of example X9 or some other example herein, wherein the computing task request is received via radio resource control (RRC) signaling.

Example X11 includes the one or more computer-readable media of example X9 or some other example herein, wherein the computing task request includes computing service information that includes one or more of: a computing session identifier, a task identifier, a service identifier, or a service function (SF) identifier.

Example X12 includes the one or more computer-readable media of example X9 or some other example herein, wherein selecting the RAN CompSF includes determining one or more resources associated with the RAN CompSF.

Example X13 includes the one or more computer-readable media of example X9 or some other example herein, wherein the media further stores instructions to provide computing offloading capability information to the UE.

Example X14 includes the one or more computer-readable media of example X13 or some other example herein, wherein the computing offloading capability information is provided to the UE via radio resource control (RRC) signaling.

Example X15 includes the one or more computer-readable media of any of examples X9-X14 or some other example herein, wherein the media stores instructions to implement a computing distributed unit (DU).

Example X16 includes one or more computer-readable media storing instructions that, when executed by one or more processors, cause a user equipment (UE) to:
send, to a computing distributed unit (Comp DU) of a next-generation NodeB (gNB), a computing task request that includes context information for the UE that is associated with a computing task to be offloaded to a cellular network, wherein the UE context information includes an identifier for the UE and security information for the UE;
receive, from the DU of the gNB, a computing setup or reconfiguration message; and
perform a computing setup or reconfiguration based on the computing setup or reconfiguration message.

Example X17 includes the one or more computer-readable media of example X16 or some other example herein, wherein the media further stores instructions to receive, from the DU of the gNB a computing response message that contains output received from a service function to which the computing task was offloaded.

Example X18 includes the one or more computer-readable media of example X16 or some other example herein, wherein the computing task request is sent via radio resource control (RRC) signaling.

Example X19 includes the one or more computer-readable media of example X16 or some other example herein, wherein the computing task request includes computing service information that includes one or more of: a computing session identifier, a task identifier, a service identifier, or a service function (SF) identifier.

Example X20 includes the one or more computer-readable media of example X16 or some other example herein, wherein the media further stores instructions to receive computing offloading capability information from the DU of the gNB.

Example X21 includes the one or more computer-readable media of example X20 or some other example herein, wherein the computing offloading capability information is provided to the UE via radio resource control (RRC) signaling.

Example X22 includes the one or more computer-readable media of any of examples X16-X21 or some other example herein, wherein the media stores instructions to implement a computing radio resource control (Comp RRC).

Example X23 includes the one or more computer-readable media of example X22 or some other example herein, wherein the Comp RRC is to support one or more of:
necessary system information broadcasts for radio frame timing and system frame number (SFN);
establishment, configuration, modification and release of compute radio bearers;
a security function;
quality of service (QoS) support;
mobility support; and
detection and recovery for radio link failures.

Example Z01 may include an apparatus comprising means to perform one or more elements of a method described in or related to any of examples 1-X23, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X23, or any other method or process described herein.

Example Z03 may include an apparatus comprising logic, modules, or circuitry to perform one or more elements of a method described in or related to any of examples 1-X23, or any other method or process described herein.

Example Z04 may include a method, technique, or process as described in or related to any of examples 1-X23, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X23, or portions thereof.

Example Z06 may include a signal as described in or related to any of examples 1-X23, or portions or parts thereof.

Example Z07 may include a datagram, packet, frame, segment, protocol data unit (PDU), or message as described in or related to any of examples 1-X23, or portions or parts thereof, or otherwise described in the present disclosure.

Example Z08 may include a signal encoded with data as described in or related to any of examples 1-X23, or portions or parts thereof, or otherwise described in the present disclosure.

Example Z09 may include a signal encoded with a datagram, packet, frame, segment, protocol data unit (PDU), or message as described in or related to any of examples 1-X23, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X23, or portions thereof.

Example Z11 may include a computer program comprising instructions, wherein execution of the program by a processing element is to cause the processing element to carry out the method, techniques, or process as described in or related to any of examples 1-X23, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, |
| | CSI-RS Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, DMRS | Demodulation Reference Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE Radio Access |
| | Network |
| GGSN | Gateway GPRS Support Node |
| GLONASS | GLObal'naya NAvigatsionnaya Sputnikovaya |
| | Sistema (Engl.: Global Navigation Satellite System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, |
| | Groupe Spécial Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec |
| | Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-I | MAC used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management |
| | Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTCmassive | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control |
| | layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time Rx Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | SS/PBCH Block Resource Indicator, Synchronization |
| Block SSBRI | Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, VLAN Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-23. (canceled)

24. An apparatus of a next generation Node B (gNB) that includes a computing distributed unit (DU), the apparatus comprising:
memory to store user equipment (UE) context information associated with a computing task to be offloaded to a cellular network; and
processing circuitry, coupled with the memory, to:
retrieve the UE context information from the memory, wherein the UE context information includes an identifier for the UE and security information for the UE;
select, based on the UE context information, a radio access network (RAN) computing service function (CompSF) to handle the computing task; and
offload the computing task to the selected RAN CompSF.

25. The apparatus of claim 24, wherein the UE context information is received via computing task request received from the UE.

26. The apparatus of claim 25, wherein the computing task request is received via radio resource control (RRC) signaling.

27. The apparatus of claim 25, wherein the computing task request includes computing service information that includes one or more of: a computing session identifier, a task identifier, a service identifier, or a service function (SF) identifier.

28. The apparatus of claim 24, wherein selecting the RAN CompSF includes determining one or more resources associated with the RAN CompSF.

29. The apparatus of claim 24, wherein the processing circuitry is further to provide computing offloading capability information to the UE.

30. The apparatus of claim 29, wherein the computing offloading capability information is provided to the UE via radio resource control (RRC) signaling.

31. The apparatus of claim 24, wherein the apparatus includes a next-generation NodeB (gNB), or a portion thereof, that includes a computing distributed unit (DU).

32. One or more non-transitory computer-readable media storing instructions that, when executed by one or more processors, cause a next-generation NodeB (gNB) to:
receive, from a user equipment (UE), a computing task request that includes UE context information associated with a computing task to be offloaded to a cellular network, wherein the UE context information includes an identifier for the UE and security information for the UE; select, based on the UE context information, a radio access network (RAN) computing service function (CompSF) to handle the computing task; and
offload the computing task to the selected RAN CompSF.

33. The one or more non-transitory computer-readable media of claim 32, wherein the computing task request includes computing service information that includes one or more of: a computing session identifier, a task identifier, a service identifier, or a service function (SF) identifier.

34. The one or more non-transitory computer-readable media of claim 32, wherein selecting the RAN CompSF includes determining one or more resources associated with the RAN CompSF.

35. The one or more non-transitory computer-readable media of claim 32, wherein the media further stores instructions that when executed cause the gNB to provide computing offloading capability information to the UE.

36. One or more non-transitory computer-readable media storing instructions that, when executed by one or more processors, cause a user equipment (UE) to:
send, to a distributed unit (DU) of a next-generation NodeB (gNB), a computing task request that includes context information for the UE that is associated with a computing task to be offloaded to a cellular network, wherein the UE context information includes an identifier for the UE and security information for the UE;
receive, from the DU of the gNB, a computing setup or reconfiguration message; and
perform a computing setup or reconfiguration based on the computing setup or reconfiguration message.

37. The one or more non-transitory computer-readable media of claim 36, wherein the media further stores instructions that when executed cause the UE to receive, from the DU of the gNB a computing response message that contains output received from a service function to which the computing task was offloaded.

38. The one or more non-transitory computer-readable media of claim 36, wherein the computing task request is sent via radio resource control (RRC) signaling.

39. The one or more non-transitory computer-readable media of claim 36, wherein the computing task request includes computing service information that includes one or more of: a computing session identifier, a task identifier, a service identifier, or a service function (SF) identifier.

40. The one or more non-transitory computer-readable media of claim 36, wherein the media further stores instructions that when executed cause the UE to receive computing offloading capability information from the DU of the gNB.

41. The one or more non-transitory computer-readable media of claim 40, wherein the computing offloading capability information is provided to the UE via radio resource control (RRC) signaling.

42. The one or more non-transitory computer-readable media of claim 36, wherein the media further stores instructions that when executed cause the UE to implement a computing radio resource control (Comp RRC).

43. The one or more non-transitory computer-readable media of claim 33, wherein the Comp RRC is to support one or more of:
necessary system information broadcasts for radio frame timing and system frame number (SFN);
establishment, configuration, modification and release of compute radio bearers;
a security function;
quality of service (QoS) support;
mobility support; and
detection and recovery for radio link failures.
